(19) United States
(12) Patent Application Publication
(10) Pub. No.: US 2012/0056815 A1
(43) Pub. Date: Mar. 8, 2012

(54) Linguistic Script Text Input Mechanism

(76) Inventor: Rajesh Mehra, Jaipur (IN)

(21) Appl. No.: 13/294,291

(22) Filed: Nov. 11, 2011

Related U.S. Application Data
(63) Continuation-in-part of application No. PCT/IN2010/000052, filed on Jan. 29, 2010.

(30) Foreign Application Priority Data
May 13, 2009 (IN) 974/DEL/2009

(51) Int. Cl. G06F 3/02

(52) U.S. Cl. 345/169; 345/168

(57) ABSTRACT

The described systems and methods relate to a user friendly, efficient and easy to use keyboard and/or keypad device for entering characters of a script, wherein the characters, diacritic marks, and extended sets thereof are assigned to one or more phonetically similar English alphabet character keys of existing keyboards/keypads. In an embodiment, to access assigned phonetically similar characters of a script or diacritic marks or extended sets thereof through the existing keyboard and/or keypad device, the desired and corresponding English alphabet character key is multi-tapped to sequentially generate and display all assigned phonetically similar characters of a linguistic script, which can be then selected based on desired text to be input.

### CROSS-REFERENCE TO RELATED APPLICATIONS

This application is a continuation-in-part claiming priority to PCT Application No. PCT/IN2010/000052, filed on Jan. 29, 2010, which designates the United States of America, and which claims priority to Indian Patent Application No. 974/DEL/2009 filed on May 13, 2009, the contents of which, in their entireties are herein incorporated by reference.

### FIELD OF INVENTION

The present invention relates to a keyboard and/or keypad for inputting multi-lingual characters. More specifically, the present invention relates to a keyboard and/or keypad for inputting characters of a script of a language based on phonetic similarity of the characters to existing keyboard and/or keypad characters.

### BACKGROUND OF THE INVENTION

Traditional computer keyboards have their keys based on English characters. An English character key pressed using a keyboard inputs a character corresponding to the key and the computer displays the character on the display device. Although multiple keyboard formats such as AZERTY, DVORAK are available and known, QWERTY format is the most commonly used format. However, even though existing keyboards are efficient while typing in English, they become difficult to use when needed for typing Non-English languages due to reasons such as large character set, complex combinations of characters intended to be used, placement of characters on existing keyboards being spread across phonetically unrelated keys, making the typing through existing keyboards difficult to remember and error prone. This problem is also evident in keypads and touch-screen text entering mechanisms of portable communication devices such as mobile phones, PDA, smart phones, among other such devices.

Traditionally, keyboards having multi-lingual character support have been designed such that some linguistic characters are accessible from a combination of English character keys or numeric codes. These keyboards are aimed at helping non-English users to use the computer for typing. Multiple patents such as U.S. Pat. No. 7,414,616, U.S. Pat. No. 7,420,543, U.S. Pat. No. 7,008,127, U.S. Pat. No. 6,281,884 among others have been disclosed to enable assignment and entering of multi-lingual characters through conventional keyboards.

U.S. Pat. No. 7,420,543 discloses a character input system using a keyboard having a plurality of keys, wherein key assignments are spatially grouped on the keyboard according to vowels, consonants and the phonetic characteristics of the characters. U.S. Pat. No. 7,414,616 patent, on the other hand, discloses an arrangement of Hindi character keys and a simplified Hindi character set provided through use of the halant character. However, these patents require users to access and use multiple keys of existing keyboard and keypads for inputting extended characters. Extended characters are characters which do not form part of the basic character set of a language but are used while formation of sentences or text sequences. Such extended characters are very common in most language scripts including Latin, Devnagri, Bangla, Telugu, among others. Typically, for using extended characters, diacritics as a mechanism is used. Also Indian Languages have extended character set which include half-letters, consonant-vowel combinations through use of diacritics as well as combined letters of consonant-consonant kind.

Some existing keyboards also use phonetic key assignments to assign multi-lingual characters to one or more English characters keys to allow incorporation of all basic multi-lingual characters. However, such keyboards do not allow assignment of extended characters to one or more English character keys and also tend to limit the number of multi-lingual characters being assigned to each English character key. This is primarily because only a limited set of toggle keys such as Shift key, have traditionally been used for entering extended characters or phonetically assigned characters. For instance, even though multiple Hindi characters are phonetically similar to ‘S’, only a small set of such characters actually get assigned to ‘S’ as beyond a certain number of assignments, such Hindi characters would not be accessible by existing toggle key and key-combination access mechanisms.

In 974/DEL/2009, characters are generated using toggle keys such as Ctrl, Alt, and Shift. However, such keyboards require the users to remember all the key combinations which lead to desired character set, require pressing of multiple keys, and there just might not be enough keys on a keyboard to accommodate all extended characters of certain languages which have large character sets.

There is therefore a need to design a Unicode enabled keyboard and/or keypad for computer and communication devices, which can efficiently and easily help a user to enter any number of multi-lingual characters or extensions thereof based on phonetic similarity.

### OBJECTS OF THE INVENTION

It is an object of the invention to provide an efficient mechanism of entering characters of a linguistic script.

It is an object of the invention to allow fast and easy input of any number of characters of a linguistic script or extensions thereof.

It is an object of the invention to use phonetic similarity between linguistic script characters including extended characters and corresponding English characters while assigning the characters of a script.

It is an object of the invention to enable assignment of characters of a linguistic script and their input for keyboards of computers and keypads of communication devices such as mobile phones, PDA, smart phones including touch-screen keypads.

It is an object of the invention to use multi-tapping mechanism to allow input of any number of characters of a linguistic script, which are assigned to corresponding English character keys based on phonetic similarity.

It is an object of the invention to enable a user to have a very short learning curve for inputting characters of a linguistic script.

### SUMMARY OF THE INVENTION

The described systems and methods relate to a user friendly, efficient and easy to use keyboard and/or keypad device for entering characters of one or more linguistic scripts, wherein the characters are assigned to one or more phonetically similar English character keys of existing keyboards/keypads.

In an embodiment, to access assigned phonetically similar linguistic characters, diacritic marks, or extended sets thereof through the existing keyboard and/or keypad device, the corresponding English character key is multi-tapped to sequentially generate or rotate and display all assigned phonetically similar characters of a linguistic script and the user can stop the rotation when the desired text is displayed.

For instance, in case ‘a’, ‘A’, ‘′’ (ascent mark) , ‘″’ (double ascent mark),
‘æ’, AE are assigned to phonetically similar English character ‘A’;
‘a’ can be displayed by pressing key ‘A’ once,
‘A’ can be displayed by pressing key ‘A’ twice,
‘′’, is displayed by pressing key ‘A’ thrice,
   ‘″’ can be displayed by pressing ‘A’ four times,
‘æ’ can be displayed is displayed by pressing ‘A’ five times
and ‘AE’ can be displayed is displayed by pressing ‘A’ six times.
   The letters are displayed as such while diacritic signs are added to the previous letter. While ‘a’ is placed next to a letter, accent mark replaces ‘a’ and adds on to the previous letter.

In an embodiment, to access assigned phonetically similar linguistic characters, diacritic marks, or extended sets thereof through the existing keyboard and/or keypad device, the corresponding English character key is multi-tapped to sequentially generate or rotate and display all assigned phonetically similar characters of a linguistic script and the user can stop the rotation when the desired text is displayed.

For instance, in case ‘u’, ‘U’ and ‘″’ (Umlaut mark) are assigned to phonetically similar English character ‘U’;
‘u’ can be displayed by pressing key ‘U’ once,
‘U’ can be displayed by pressing key ‘U’ twice,
And ‘″’ is displayed by pressing key ‘U’ thrice.

In a preferred embodiment, all diacritic signs are placed on phonetically similar keys. Such assignment can make it possible to write ‘hören’ by pressing keys ‘H’, ‘O’, ‘U’, ‘U’, ‘U’, ‘R’, ‘E’, ‘N’.

In a preferred embodiment, all diacritic signs are placed on phonetically similar keys. Such assignment can make it possible to write ‘égaux’ by pressing keys ‘E’, ‘A’, ‘A’, ‘A’, ‘G’, ‘A’, ‘U’, ‘X’.

In an embodiment, to access assigned phonetically similar linguistic characters, diacritic marks, or extended sets thereof through the existing keyboard and/or keypad device, the corresponding English character key is multi-tapped to sequentially generate or rotate and display all assigned phonetically similar characters of a linguistic script and the user can stop the rotation when the desired text is displayed.

For instance, in case ‘e’, ‘E’, ‘ [symbol] ’(Euro), ‘η’(Eng Small), ‘ [symbol] ’ (Eng Capital), ‘ [symbol] ’(eth small) and ‘ [symbol] ’(eth Capital) are assigned to phonetically similar English character ‘E’.

In another implementation, multi-tapping of one English character key would present/display the assigned phonetically similar characters of a script in a clockwise manner i.e. for character key ‘E’, each multi-tap would sequentially show ‘e’→‘E’→‘ [symbol] ’→‘η’→‘ [symbol] ’→‘ [symbol] ’→‘ [symbol] ’→‘e’. In an embodiment, a toggle key such as Shift or Arrow-keys can be used along with multi-tapping to reverse the presentation/display sequence of the characters such that when ‘Shift’ is pressed during multi-tapping, the sequence of presented characters of the script reverses. This enables the user to access the characters towards the end of a sequence faster and more efficiently.

In an embodiment, to access assigned phonetically similar linguistic characters, diacritic marks, or extended sets thereof through the existing keyboard and/or keypad device, the corresponding English character key is multi-tapped to sequentially generate or rotate and display all assigned phonetically similar characters of a linguistic script and the user can stop the rotation when the desired text is displayed. For instance, in case ‘ [symbol] ’, ‘ [symbol] ’, ‘ [symbol] ’, ‘ [symbol] ’, are assigned to phonetically similar English character ‘S’;
‘ [symbol] ’ can be displayed by pressing ‘S’ once,
‘ [symbol] ’ can be displayed by pressing ‘S’ twice,
‘ [symbol] is displayed by pressing ‘S’ thrice
and ‘ [symbol] ’ can be displayed by pressing ‘S’ four times.

In a preferred embodiment, to access extended character set such as ‘ [symbol] ’, English character key ‘S’ can be pressed followed by the English character key ‘A’. To access extended character set such as ‘ [symbol] ’, English character key ‘S’ can be pressed followed by the English character key ‘E’. To access extended character set such as ‘ [symbol] ’, English character key ‘S’ can be pressed followed by the English character key ‘E’, ‘E’. To access extended character set such as ‘ [symbol] ’, English character key ‘S’ can be pressed followed by the English character key ‘I’. To access extended character set such as ‘ [symbol] ’, English character key ‘S’ can be pressed followed by the English character key ‘I’, ‘I’.

In a preferred embodiment, the diacritic signs ‘ [symbol] ’, ‘ [symbol] ’, ‘ [symbol] ’, ‘ [symbol] ’, ‘ [symbol] ’, ‘ [symbol] ’, ‘ [symbol] ’, ‘ [symbol] ’, ‘ [symbol] ’, ‘ [symbol] ’, ‘ [symbol] ’ are placed on phonetically similar keys ‘A’, ‘E’, ‘I’, ‘O’, ‘U’, ‘N’ and ‘H’. In this arrangement ‘ [symbol] ’ is placed on ‘A’ and ‘∂’ on key ‘E’. Such assignment can make it possible to write ‘ [symbol] ’ by pressing keys ‘M’, ‘E’, ‘R’, ‘A’. In a preferred embodiment, it is possible to write ‘ [symbol] ’ by pressing keys ‘R’, ‘A’, ‘J’, ‘E’, ‘S’, ‘S’.

In a preferred embodiment, phonetically similar basic letters-vowel or consonant, vowel or consonant diacritic marks and extended compound letters may be mapped to one or more keys. Basic vowel letters ‘ [symbol] ’, ‘ [symbol] ’, ‘ [symbol] ’, and diacritic signs ‘ [symbol] ’, ‘ [symbol] ’, may be mapped to same key ‘E’ and displayed by multi-tapping the key ‘E’ in the order desired. The letters ‘ [symbol] ’, ‘ [symbol] ’, ‘ [symbol] ’, are displayed as such when key ‘E’ is pressed as a first letter of a word while diacritic signs are added to consonants, if key ‘E’ is pressed after a consonant. If it is desired to have ‘ [symbol] ’ as a second letter of a word then the sequence on multi-tapping key ‘E’ would be ‘ [symbol] ’, ‘ [symbol] ’, ‘ [symbol] ’. Dotted circles in diacritic signs indicate space for consonants Such assignment can make it possible to write ‘ [symbol] ’ by pressing keys ‘H’ and ‘E’. Also multi-tapping makes it possible to write ‘ [symbol] ’ by pressing keys ‘H’, ‘E’, ‘E’.

In a preferred embodiment, a dedicated key ‘Q’ may contain a ‘joiner’. To access half-letter ‘ [symbol] ’, press the English character key ‘S’ to write ‘ [symbol] ’ and then a dedicated key can be pressed. To access half-letter ‘ [symbol] ’, the letter ‘ [symbol] ’ is written and then a dedicated key is pressed.

In another embodiment, to access assigned extended character set such as ‘ [symbol] ’, ‘ [symbol] ’, ‘ [symbol] ’, etc. the English character key ‘S’ and then a dedicated key ‘W’ can be pressed repeatedly to access all such possible extended character set options. In another embodiment, to access assigned extended character set such as ‘ [symbol] ’, ‘ [symbol] ’, ‘ [symbol] ’, ‘ [symbol] ’, ‘ [symbol] ’, ‘ [symbol] ’, ‘ [symbol] ’, ‘ [symbol] ’, ‘ [symbol] ’, ‘ [symbol] ’, ‘ [symbol] ’, ‘ [symbol] ’, ‘ [symbol] ’, ‘ [symbol] ’ etc., the English character key ‘D’ can be pressed to write ‘ [symbol] ’ and then a dedicated key ‘W’ can be pressed repeatedly to access all such possible extended character set options.

In an embodiment the diacritic signs ‘ [symbol] ’, ‘ [symbol] ’, ‘ [symbol] ’, ‘ [symbol] ’, ‘ [symbol] ’, ‘ [symbol] ’, ‘ [symbol] ’, ‘ [symbol] ’, ‘ [symbol] ’, ‘ [symbol] ’, ‘ [symbol] ’ in addition to their placement on phonetically similar keys ‘A’, ‘E’, ‘I’, ‘O’, ‘U’, ‘N’ and ‘H’ can also be placed on a single dedicated key and added to a consonant sequentially by repeatedly pressing the dedicated key.

In an embodiment half-letters such as ‘ [symbol] ’ and ‘ [symbol] ’ could be placed on key ‘K’ and accessed by multi-tapping key ‘K’.

In yet another embodiment, all assigned phonetically similar characters of a linguistic script and extended sets thereof can be displayed or printed on the corresponding English character key of keyboard/ keypad. In another embodiment, a partial set of assigned phonetically similar characters of a linguistic script or extended set thereof, can be displayed or printed on the corresponding English character key. In yet another embodiment, selection of such a partial set can be done based on one or more of user convenience, frequency of use of such assigned phonetically similar characters of a script or extended set thereof, size of keyboard, number of assigned phonetically similar characters of a script or extended set thereof for each corresponding English character key. For instance, as English character key ‘M’ is only assigned with ‘ [symbol] ’ and there is more space on the key ‘M’, extended characters such as ‘ [symbol] ’, ‘ [symbol] ’, and ‘ [symbol] ’ can also be assigned to ‘M’ only for efficient access of frequently used extended characters and also effective use of the space on the key. In a preferred embodiment, each English character key can have different number of phonetically similar characters of a script assigned thereto.

In an embodiment, multi-tapping is used to access each assigned phonetically similar characters of linguistic script and extended sets thereof can also be accessed with use of toggle keys or other combination of keyboard/keypad keys. In yet another embodiment, toggle keys such as Shift, Alt, and Ctrl keys can be used to reverse the order in which the assigned phonetically similar characters of script and extended sets thereof are presented to users for selection.

In another embodiment, phonetically similar characters of a script and extended set thereof can also be assigned to keys of a keypad such as that of a mobile phone, smart phone, kiosks, PDA among others. Such keypads can include both physical keypads of mobile phones and touch-screen keypads, which can further have multiple layouts. For instance, in mobile phone keypads which have keys 0-9 in a 3×4 layout and English characters assigned thereto such as characters a, b, and c being assigned to numeric key ‘2’, all phonetically similar characters of a script and extended set thereof corresponding to English characters a, b, and c, can be assigned to numeric key ‘2’. Other conceivable formats for assignment of phonetically similar characters of a script too can be applied for such mobile keypads, which have less space with multiple English characters assigned to each physical key. For touch screen communication devices such as PDA's, Kiosks, having conventional QWERTY keyboard layout, assignment as described and enabled above can be implemented.

### BRIEF DESCRIPTION OF THE DIAGRAMS

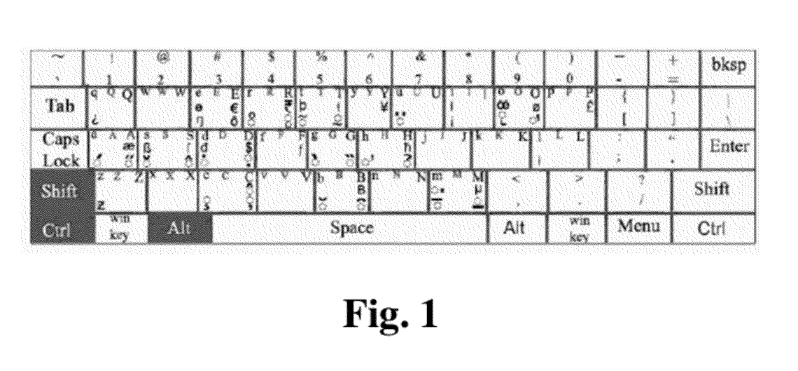

FIG. 1 illustrates a keyboard and/or keypad device having one or more phonetically similar characters of Latin script and their extended character set, assigned to English character keys. The languages which can be input with this single input device are: Albanian, Azerbaijani, Bosnian, Catalan, Chechen Latin, Cheyenne, Cimbrian, Croat Latin, Czech, Danish, Dutch, English, Estonian, Faeroese, Finnish, French, Gaurani, German, Hawaiian, Icelandic, Irish, Italian, Kurdish, Latvian, Lithuanian, Maltese, Norwegian, Polish, Portuguese, Quechua, Romanian, Slovak, Slovenian, Sorbian, Spanish, Swedish, Turkish, Welsh.

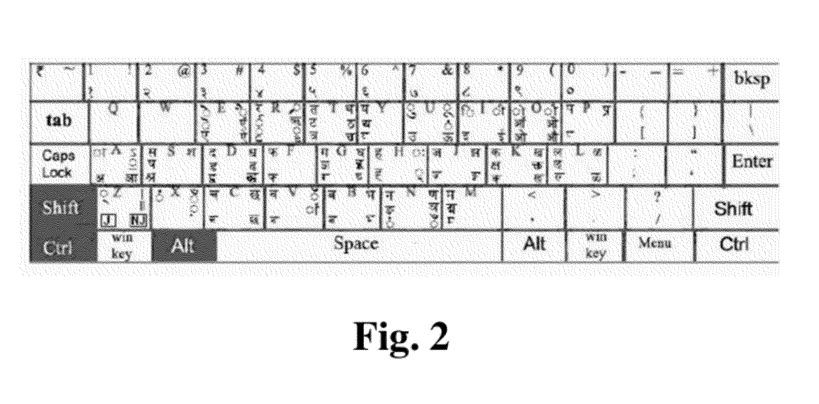

FIG. 2 illustrates a keyboard and/or keypad device having one or more phonetically similar characters of Devnagri script and their extended character set, assigned to English character keys. The languages which can be input with this single input device are: Hindi, Marathi, Sanskrit, Konkani, Sindhi, Nepali.

### DETAILED DESCRIPTION

This disclosure is directed to a user friendly, efficient and easy to use keyboard and/or keypad device for entering characters of a lingual script, wherein phonetically similar characters of the script and their extended character sets can be assigned to one or more English character keys of existing keyboards/keypads.

Multiple and varied implementations and embodiments are described below. In the following section, an exemplary environment that is suitable for practicing various implementations is described. After this discussion, representative implementations of systems, devices, and processes for implementing a keyboard and/or keypad device for entering characters of a script are described.

A detailed description of the invention is provided by reference to the drawing FIGS. 1 and 2. The figures are intended to allow those who have ordinary skills in the art to understand the scope of the present invention. Description is given, considering mapping of Latin and Devnagri script onto the English alphabet character keys of keyboard. Although the present invention is described in connection with exemplary embodiment with Latin and Devnagri scripts, it is not limited to only these script. This invention can be described for other Indic linguistic scripts such as Bangla, Gujarati, Gurmukhi, Kannada, Tamil, Telugu, Malayalam, Oriya etc and for other International linguistic scripts such as Cyrillic, Japanese, Sinhala; naming just a few. It is to be understood that omissions and substitutions of equivalents are intended to cover the application or implementation. Also, it is to be understood that the phraseology and terminology used herein is for the purpose of description and should not be regarded as limiting.

Further, even though most of the present disclosure is explained with reference to a computer keyboard having conventional QWERTY keyboard layout, it should be appreciated that the invention works on phonetic similarity and therefore no limitation would be applicable in case any other keyboard layout format is used. Also, keyboards with Non-English languages as their main languages can also be used for the proposed invention as the primary focus is on phonetic similarity of characters of a script and extended character set thereof. Further the disclosure is also directed to all touch screen devices having keyboard/keypad mechanisms for entering text. The disclosure is also directed to be applicable to all physical keypads of communication devices such as mobile phones having conventional 3×4 keypad layout for entering text.

In an implementation, an on-screen picture of keyboard (virtual keyboard) can be provided. We can also provide a set of replacement keys or stickers. The keys may be removed from a keyboard and the replacement keys (or stickers affixed to the top of the keys) can be installed to allow a user to identify the Hindi language character that is mapped to the particular key. A keyboard skin may also be provided. A keyboard skin may be configured to fit over an existing keyboard. The skin may be printed or marked with characters to indicate which characters are mapped to particular keys.

FIG. 1 illustrates layout for a computer keyboard, also commonly referred to as a “QWERTY” keyboard. The keyboard includes a set of character keys, numeric keys, toggle keys (SHIFT, CONTROL and ALT keys) and function keys and additional feature keys. Character keys are hereinafter commonly referred to as key. Each English character key can generate two characters i.e., small letter and a capital letter. Small letter can be obtained from the keyboard by pressing the character key. Capital letter can be obtained by holding the SHIFT key and pressing the character key or by changing the “Caps Lock” to “ON” state.

In an embodiment, phonetically similar characters of a script and their extended character sets can be assigned to one or more English character keys of existing keyboards/keypads. Phonetically similar characters are characters which sound similar when pronounced but may or may not have the same meaning For instance, English character key “S” is assigned with English characters “S” and “s” by default. Characters in Hindi language which are phonetically similar to ‘S’ include ‘ [symbol] ’, ‘ [symbol] ’, ‘ [symbol] ’, and ‘ [symbol] ’. These can be assigned or mapped to key ‘S’. In the same manner, other English character keys of the keyboard can be assigned with respective phonetically similar Devnagri character.

In an embodiment, each English character key can be assigned none or more phonetically similar characters of a script and extended character sets thereof. For instance, as illustrated in FIG. 2, English character key ‘Q’ is not assigned any character. In yet another embodiment, each English character key can have more number of assigned phonetically similar characters than are shown on the respective key. For instance, even though English character key ‘D’ shows 6 phonetically similar characters being assigned, ‘D’ can actually have many more characters or extended character sets thereof assigned to them. Each Hindi character has multiple extended characters, which are obtained by combining the Hindi characters with vowels or consonants and which can therefore also be placed on the phonetically similar key apart from being present on a separate key.

In an embodiment, extended character sets too can be assigned to the main character's assignment only. For instance, extended character ‘ [symbol] ’ can also assigned to ‘D’ itself but not shown on the corresponding key. In an embodiment, a partial set of actually assigned phonetically similar characters of a script and their extended character sets can be displayed on the corresponding English character keys based on one or more of frequency of usage, user preferences, ease of use, and size of keyboards and keys thereof. For instance, in case each key of a keyboard can accommodate a maximum of 6 characters of a script, six most frequently used multi-lingual characters or extended characters thereof can be displayed on the key and the remaining characters, even though not displayed, are assigned to the same key and can be accessed by multi-tapping the key.

In a preferred embodiment, use of extended characters, as described above, can be made accessible by a combination of keys. For instance, pressing of ‘D’ followed by ‘A’ can help us access ‘ [symbol] ’. In yet another example, all phonetically similar characters of a script can be displayed on the corresponding English character key and their extended versions can be displayed in case there is space available on the key, else can always be accessed as they are assigned to the same key.

In an embodiment, a user can enter a desired character of a script through the use of corresponding English character to which it is assigned based on phonetic similarity. In a preferred embodiment, in cases where an English character key is assigned to two or more phonetically similar characters of a script or extended character sets thereof, such assigned phonetically similar characters of a script or extended character sets thereof can be accessed by tapping the corresponding English character key till the desired character of a script is selected.

In an embodiment, Hindi character ‘ [symbol] ’ is assigned to phonetically similar English character ‘M’, and tapping of ‘M’ once can give the desired character ‘ [symbol] ’. Hindi character ‘ [symbol] ’ which is also phonetically similar to English character ‘M’ and hence assigned to ‘M’. Hindi character ‘ [symbol] ’ can be entered by tapping the key twice. Similarly, Hindi characters ‘ [symbol] ’ and ‘ [symbol] ’, can be entered by tapping character key ‘M’, three and four times respectively. Therefore, multi-tapping of a specific English character key allows all phonetically similar characters of a script and extended character set thereof, which are assigned to the respective key, to be selected sequentially and then chosen accordingly by the user based on the desired text.

In an embodiment, all phonetically similar characters of a script and extended character sets thereof can be accessed by multi-tapping the corresponding English character key. Characters, which are not displayed on the keyboard, can be accessed by multi-tapping the key till the desired character is displayed on the display of the system. In another embodiment, toggle keys or the other desired keys of the keyboard can also be used and configured in addition to multi-tapping to access the assigned phonetically similar characters of a script and extended character set thereof. For instance, in order to enter ‘ [symbol] ’, a user can multi-tap the key ‘S’ three times and then press ‘A’ to get the desired text. In yet another embodiment, multiple consonant combinations can also be configured to be placed on a single phonetically similar character, for instance, ‘ [symbol] ’, which is a combination of ‘ [symbol] ’ and ‘ [symbol] ’, can be placed on ‘T’ itself and accessible through repeated tapping. In another embodiment, the above consonant combination can always be combined by using multi-tap with combination of different keys or such a word can also be assigned to another dedicated key such as ‘W’.

In an embodiment, certain other keys of the keyboard can also be configured and assigned, dedicated and frequently used characters/halants so that a user does not always need to depend on multi-tapping as the sole mechanism for text character input. Further, keyboard English character keys such ‘Z’, which are not assigned to any phonetically similar Hindi characters, can be used for assignment of commonly used ‘halant’ and used in combination with multi-tapping to get the desired character.

In an embodiment, the communication device has a standard QWERTY keypad and therefore allows a similar multi-lingual character assignment as discussed above. In another embodiment, the communication device can be a mobile phone, smart phone, pocket PC, tablet PC, PDA among other devices in which the proposed system can be implemented. In an embodiment, the communication device has a display. In another embodiment, the communication device can have a virtual keypad or a touch screen keypad having same or different key layout, wherein phonetically similar characters and extended sets thereof can be assigned and accessed through multi-tapping on touch screen.

In an embodiment, conventional 3×4 keypads have more than one English character assigned to each key of the keypad. For instance, the key corresponding to numeral ‘2’ has three English characters a, b, and c. In such a case, in an embodiment, all characters of a script, which are phonetically similar to English characters a, b, and c can be assigned to the key corresponding to numeral ‘2’. In one embodiment, a first phonetically similar alphabet of character corresponding to the character ‘a’ may be displayed by tapping the numeral ‘2’ key once. Similarly, in an embodiment, first phonetically similar alphabet of character corresponding to the character ‘B’ may be displayed by tapping the numeral ‘2’ key twice. Similarly, in an embodiment, first phonetic alphabet of character of a script corresponding to the character ‘C’ may be displayed by tapping the numeral ‘2’ key thrice. Further phonetic variations of ‘character of a script corresponding to the character ‘C′’ may be obtained by using ‘Up’ or ‘Down’ arrow keys. It would be understood by one ordinarily skill in the art that it is possible to display the phonetic characters corresponding to the number of tapping times of a particular numeral key in a number of different permutations and combinations. Similarly, all characters of a script and their extended character set which are phonetically similar to English characters d, e, and f, can be assigned to the key corresponding to numeral ‘3’.

The proposed system and method of assignment can therefore work with computer keyboards and all keypads of communication devices including mobile phones, kiosks, PDA's, touch phones, smart phones, among other devices.

The present invention provides an efficient mechanism of entering characters of a script.

The present invention allows fast and easy input of any number of characters of a script or extensions thereof.

The present invention uses phonetic similarity between characters of a script and corresponding English characters while assigning the characters.

The present invention enables multi-lingual character assignment and input for keyboards of computers and keypads of communication devices such as mobile phones, PDA, smart phones including touch-screen keypads.

The present invention uses multi-tapping mechanism to allow input of any number of characters of a script, which are phonetically assigned to corresponding English characters.

What is claimed is:

1. A keyboard/keypad for entering characters of a linguistic script and extended character sets thereof comprising:
one or more keys, wherein said one or more keys are assigned said characters of said linguistic script and extended character sets thereof based on phonetic similarity between characters corresponding to said one or more keys and said characters of said linguistic script and extended character sets thereof;
a control means for enabling a user to input desired character of said linguistic script by multi-tapping a key to which said desired character of said linguistic script is assigned till said desired character is displayed.

2. The keyboard/keypad as claimed in claim 1, wherein said keyboard/keypad comprises a computer keyboard, a mobile phone keypad, a touch-screen keypad, a kiosk keypad, a PDA keypad, a smart-phone keypad, and a communication device keypad.

3. The keyboard/keypad as claimed in claim 1, wherein said one or more keys correspond to English characters and said keyboard/keypad is a QWERTY keyboard or another format.

4. The keyboard/keypad as claimed in claim 1, wherein said keyboard/keypad is a 3×4 mobile keypad.

5. The keyboard/keypad as claimed in claim 1, wherein said one or more keys display all assigned said characters of said linguistic script and extended character sets on said keys itself.

6. The keyboard/keypad as claimed in claim 1, wherein said one or more keys display a partial set of assigned said characters of said linguistic script and extended character sets thereof on said keys based on one or more of frequency of use of assigned said characters of said linguistic script and extended character sets thereof, size of said one or more keys, size of said keyboard/keypad, user preferences, and ease of use and access of said characters of said linguistic script and extended character sets thereof.

7. The keyboard/keypad as claimed in claim 1, wherein said extended character sets of said characters of said linguistic script are accessible through one or more of separate dedicated keys, two or more keys of said keyboard/ keypad which are phonetically similar to constituent of said extended character sets, and single phonetically similar key of said keyboard/keypad.

8. The keyboard/keypad as claimed in claim 1, wherein consonant combination of said characters of said linguistic script are accessible through one or more of separate dedicated keys, combination of two or more keys of said keyboard/keypad which are phonetically similar to constituent of said consonant combination, and single phonetically similar key of said keyboard/keypad.

9. A method for entering characters of a linguistic script and extended character sets thereof through a keyboard/keypad comprising:
assigning said characters of said linguistic script and extended character sets thereof to one or more keys of said keyboard/keypad based on phonetic similarity between characters corresponding to said one or more keys and said characters of said linguistic script and extended character sets thereof;
enabling a user to input desired character of said linguistic script by repeatedly tapping a key to which said desired character of said linguistic script is assigned till said desired character is displayed.

10. The method of claim 9, wherein said extended character sets of said characters of said linguistic script are accessible through one or more of separate dedicated keys, two or more keys of said keyboard/keypad which are phonetically similar to constituent of said extended character sets, and single phonetically similar key of said keyboard/keypad.

11. The method of claim 9, wherein consonant combination of said characters of said linguistic script are accessible through one or more of separate dedicated keys, combination of two or more keys of said keyboard/keypad which are phonetically similar to constituent of said consonant combination, and single phonetically similar key of said keyboard/keypad.

12. The method of claim 9, wherein said one or more keys display a partial set of assigned said characters of said linguistic script and extended character sets thereof on said keys based on one or more of frequency of use of assigned said characters of said linguistic script and extended character sets thereof, size of said one or more keys, size of said keyboard/keypad, user preferences, and ease of use and access of said characters of said linguistic script and extended character sets thereof.

13. The method of claim 9, wherein said repeated tapping of said key sequentially displays said assigned characters in one or more of clockwise direction, anti-clock wise direction, and user customized direction.

14. The method of claim 9, wherein one or more toggle or arrow keys can be used along with said repeated tapping to access said desired character and extended set thereof of said linguistic script.
